(19) United States
(12) Patent Application Publication
(10) Pub. No.: US 2006/0119083 A1
(43) Pub. Date: Jun. 8, 2006

(54) SEATING SYSTEM FOR AUTOMOTIVE VEHICLE

(75) Inventors: JAMES Z. PENG, YPSILANTI, MI (US); JOSEPH E. ABRAMCZYK, FARMINGTON HILLS, MI (US); KURT L. EWING, PLYMOUTH, MI (US); JOHN J. PINKERTON, CANTON, MI (US); BRIAN ROBERT SPAHN, PLYMOUTH, MI (US)

Correspondence Address: Artz & Artz P.C., 28333 Telegraph Road, Suite 250, Southfield, MI, 48034, US

(73) Assignee: FORD MOTOR COMPANY, DEARBORN, MI (US)

(21) Appl. No.: 10/904,900

(22) Filed: Dec. 3, 2004

(51) Int. Cl. B60R 21/22; B60R 21/16

(52) U.S. Cl. 280/730.2; 280/743.2

(57) ABSTRACT

A seating system for an automotive vehicle includes a seat frame mounted upon a vehicle floorpan. A seat cushion and seatback are mounted to the seat frame. A side airbag is mounted to an outboard portion of the seatback and has at least one flexible tension member attached to and extending between the seat frame and an external surface of the airbag. The flexible tension member maintains the airbag in an appropriate position during a deployment event.

### BACKGROUND OF THE INVENTION

1. Field of the Invention

The present invention relates to a seating system for an automotive vehicle having a seat-mounted airbag which is positioned at least in part by a flexible tension member extending from the seat's structure to the airbag.

2. Disclosure Information

Side airbags have been used in automotive vehicles for several years. Such airbags may be mounted either in a door or other closure portion of a vehicle, such as a quarter trim panel. Alternatively, a side airbag may be mounted in a seatback at an occupant location within the vehicle. Mounting within the seatback offers an advantage inasmuch as the side airbag is maintained in a appropriate position vis-à-vis the occupant of the seat because the side airbag is positioned or repositioned along with the seatback itself.

Side airbags mounted upon a seatback have a limited package envelope which must be carefully managed because the side airbag must be projected forwardly and alongside the occupant of the seat in order to provide proper interaction between the airbag and the vehicle occupant. Because of the need to project the airbag, it is sometime possible for a side airbag to move out of position during a deployment sequence. U.S. Pat. No. 5,730,464 discloses a side airbag with a tether 70 is attached to upper and lower portions of the airbag. Unfortunately, the tether is attached only to the airbag and cannot stabilize the airbag to any greater extent than is otherwise promoted by the attachment of the airbag itself to the seat or side panel of the vehicle. A system according to the present invention overcomes the shortcoming possible with the tether of the '464 patent.

### SUMMARY OF THE INVENTION

A seating system for an automotive vehicle includes a seat frame mounted upon a vehicle floorpan, with the seat frame having a seat cushion portion and a seatback portion. A seat cushion is attached to the seat cushion portion of the frame and the seatback is mounted to the seatback portion of the seat frame. A side airbag is mounted to an outboard portion of the seatback and has at least one flexible tension member having a first end attached to the seat frame and a second end attached to an external surface of the airbag. In one embodiment, the flexible tension member comprises a cable having a first end attached to the seat cushion frame. Alternatively, a first end of the flexible tension member may be attached to a lower portion of the seatback frame. According to yet another alternative, a first end of the flexible tension member may be attached to an upper portion of the seatback frame.

The second end of the previously described flexible tension member is preferably attached to an outboard portion of the side airbag. In one embodiment, the second end of the flexible tension member is attached to a lower outboard portion of the airbag.

A seating system according to the present invention may further include a second flexible tension member having a first end attached to an upper portion of the seatback, and a second end attached to an upper portion of the airbag.

According to another aspect of the present invention, the flexible tension members described herein may include either a cable member, or a fabric panel, or a combination of the two. Where a fabric panel is employed, such a panel in a first embodiment will have a first edge attached to the seatback and a second edge attached to the airbag at either a lower portion of the airbag or at an inboard upper portion of the airbag. Where a fabric panel is used, according to the present invention, the panel may be attached to substantially the entire lower edge of the airbag. This attachment will comprise a linear joint extending along a lower portion of the airbag. A second linear joint will extend along the seatback frame, uniting the fabric panel and the seatback.

A system according to the present invention is particularly useful where the airbag is mounted to an outboard side of the seatback.

It is an advantage of the present invention that a system according to the present invention positions a side airbag for maximum utility during an inflation event.

It is a further advantage of the present invention that a system according to this invention increases the utility of an airbag having a smaller module suitable for mounting within a seatback.

Other advantages, as well as objects and features of the present invention, will become apparent to the reader of this specification.

### BRIEF DESCRIPTION OF THE DRAWINGS

FIG. 1 is a frontal elevation of a seating system according to the present invention having a single lower flexible tension member.

FIG. 2 is similar to FIG. 1 but shows a flexible tension member including a fabric panel.

FIG. 3 shows a seating system according to the present invention having a single upper flexible tension member.

FIG. 4 is similar to FIG. 3 but shows a single upper flexible tension member including a fabric panel.

FIG. 5 illustrates a seating system according to the present invention having upper and lower flexible tension members.

FIG. 6 illustrates an embodiment according to the present invention having upper and lower flexible tension members including fabric panels.

### DETAILED DESCRIPTION OF THE PREFERRED EMBODIMENTS

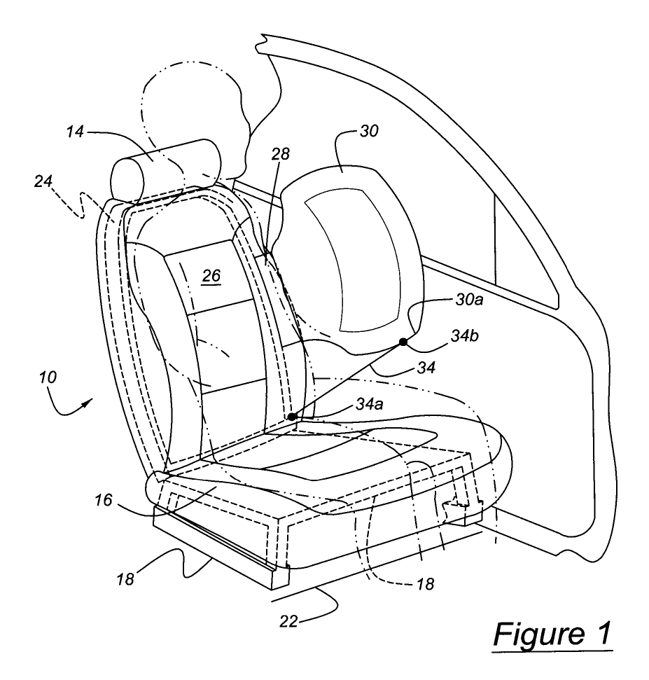

As shown in FIG. 1, seat system 10 includes headrest 14, which is mounted upon seatback 26 having seatback frame 24. Seat cushion 16 is mounted upon seat cushion frame 18, which in turn is mounted upon floorpan 22. Side airbag 30 has a lower flexible tension member, 34, which assists in the inflated positioning of airbag 30. Side airbag 30 is itself mounted to module 28, which is positioned at the approximate midpoint of the outboard side of seatback 26. Lower flexible tension member 34 is shown in FIG. 1 as being a cable having a first end, 34a, attached to frame 24 of seatback 26 and a second end, 34b, attached to lower outboard portion 30a of airbag 30. Flexible tension member 34 restrains airbag 30 from moving upwardly when airbag 30 is in an inflated state.

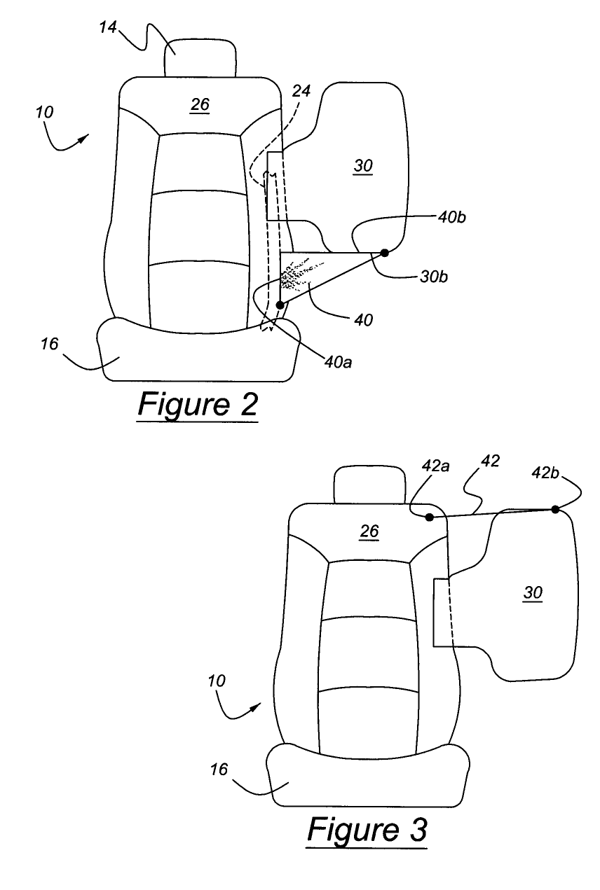

FIG. 2 shows an embodiment of the present invention in which fabric panel 40 is positioned between lower edge portion 30b of airbag 30 and seatback 26. Fabric panel 40 has a first edge, 40a, which functions as a linear joint between panel 40 and seatback 26. Fabric panel 40 also has a second edge, 40b, which functions as a linear joint between panel 40 and lower portion 30b of airbag 30. In a preferred embodiment, panel 40 includes a panel of airbag fabric which is sewn to airbag 30 and also to seatback 26. Panel 40 is preferably mounted to seatback frame 24. Those skilled in the art will appreciate in view of this disclosure that panel 40 may be attached to airbag 30 and to seatback 26 by any of a number of known methods and structures such as adhesive bonding, thermal bonding, molding in place, riveting, and other means.

FIG. 3 illustrates an embodiment in which an upper flexible tension member, 42, is mounted with a first end 42a attached to an upper portion of seatback 26, and a second end, 42b, mounted to an outboard upper portion of airbag 30.

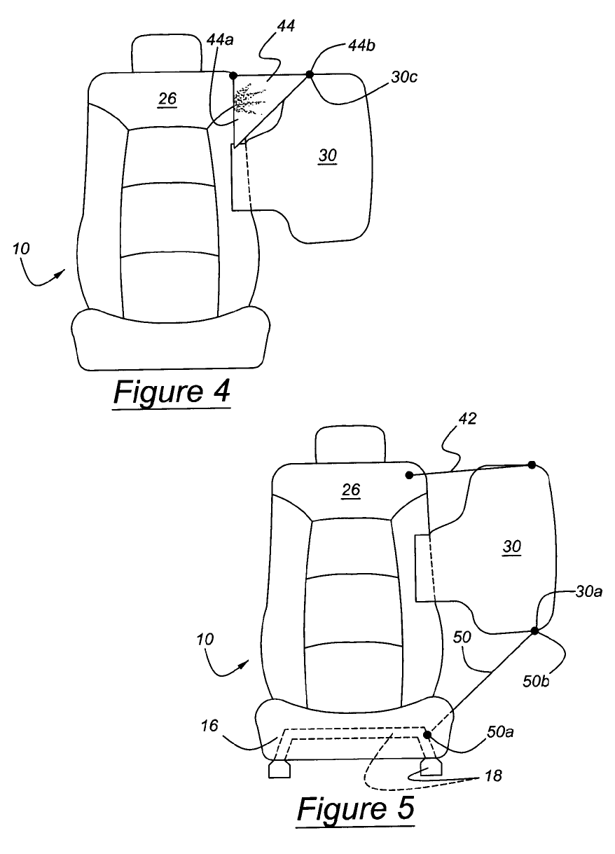

FIG. 4 shows another embodiment according to the present invention in which fabric panel 44 has a first end, 44a, mounted to an outboard portion of seatback 26 and a second end, 44b, attached to an upper inboard portion, 30c, of airbag 30.

FIG. 5 illustrates an embodiment having both upper flexible tension member 42 and lower flexible tension member, 50, having a first end, 50a, which is mounted to seat cushion frame 18, and a second end, 50b, mounted to outboard lower portion 30a of airbag 30. Cables 42 and 50 act in concert to maintain airbag 30 in the illustrated position, while avoiding either upward or downward displacement of airbag 30.

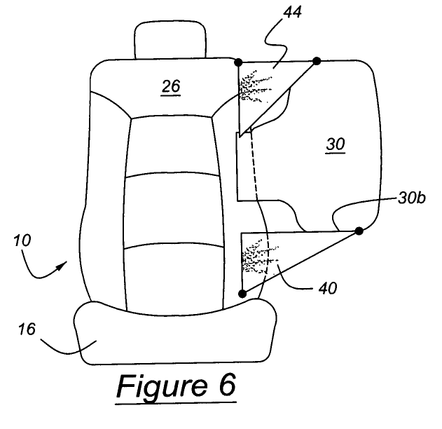

FIG. 6 discloses an embodiment in which fabric panel 44 extends between an upper inboard portion of airbag 30 and an upper portion of seatback 26, with fabric panel 40 mounted between a lower portion of seatback 26 and a lower portion, 30b, of airbag 30. As with the embodiment of FIG. 5, panels 44 and 40 act in concert to maintain airbag 30 in the illustrated position, while avoiding either upward or downward displacement of airbag 30.

Although the present invention has been described in connection with particular embodiments thereof, it is to be understood that various modifications, alterations, and adaptations may be made by those skilled in the art without departing from the spirit and scope of the invention set forth in the following claims. For example, the previously described flexible tension members could include fabric panels having cable reinforcements incorporated therein.

What is claimed is:

1. A seating system for an automotive vehicle, comprising:
a seat frame mounted upon a vehicle floorpan, with said seat frame having a seat cushion portion and a seatback portion;
a seat cushion attached to a seat cushion portion of said seat frame;
a seatback mounted to said seatback portion of said seat frame;
an airbag mounted to an outboard portion of said seatback; and
at least one flexible tension member having a first end attached to said seat frame and a second end attached to an external surface of said airbag.

2. A seating system according to claim 1, wherein said at least one flexible tension member comprises a cable having a first end attached to said seat cushion frame.

3. A seating system according to claim 1, wherein said first end of said at least one flexible tension member is attached to a lower portion of said seatback frame.

4. A seating system according to claim 1, wherein said first end of said at least one flexible tension member is attached to an upper portion of said seatback frame.

5. A seating system according to claim 1, wherein said second end of said at least one flexible tension member is attached to an outboard portion of said airbag.

6. A seating system according to claim 1, wherein said second end of said at least one flexible tension member is attached to an lower outboard portion of said airbag.

7. A seating system according to claim 6, further comprising a second flexible tension member having a first end attached to an upper portion of said seatback and a second end attached to an upper portion of said airbag.

8. A seating system according to claim 7, wherein each of said flexible tension members comprises a cable member.

9. A seating system according to claim 7, wherein each of said flexible tension members comprises a generally planar fabric panel.

10. A seating system according to claim 7, wherein said second end of said at least one flexible tension member is attached to a lowermost outboard portion of said airbag, and said second end of said second flexible tension member is attached to an uppermost outboard portion of said airbag.

11. A seating system according to claim 1, wherein said flexible tension member comprises a fabric panel having a first edge attached to said seatback and a second edge attached to said airbag.

12. A seating system according to claim 1, wherein said flexible tension member comprises a fabric panel having a first edge attached to an outboard portion of said seatback and a second edge attached to a lower portion of said airbag.

13. A seating system according to claim 12, wherein said second edge of said fabric panel is attached to substantially an entire lower edge of said airbag.

14. A seating system according to claim 1, wherein said airbag is mounted to an outboard portion of said seatback, proximate the midpoint of said seatback.

15. A seating system for an automotive vehicle, comprising:
a seat cushion attached to a frame mounted upon a vehicle floorpan;
a seatback comprising a frame mounted to said seat cushion frame;
a side airbag mounted to an outboard portion of said seatback; and
a flexible tension member having a first end attached to an outboard lower portion of said seatback frame and a second end attached to a lower outboard portion of said airbag, whereby said airbag will be restrained from moving upwardly when it is in an inflated state.

16. A seating system according to claim 15, wherein said flexible tension member comprises a cable.

17. A seating system according to claim 15, wherein said flexible tension member comprises a fabric panel having a first end formed as a linear joint extending along said seatback frame and a second end formed as a linear joint extending along a lower portion of said airbag.

18. A seating system according to claim 15, wherein said airbag is mounted to an outboard side of said seatback at approximately the midpoint of said seatback side.

19. A seating system according to claim 15, wherein said flexible tension member is external to said airbag.

20. A seating system according to claim 15, further comprising a second flexible tension member having a first end attached to an upper portion of said seatback and a second end attached to an inboard upper portion of said airbag.

21. A seating system according to claim 20, wherein said second flexible tension member comprises a fabric panel.

22. A seating system according to claim 20, wherein said second flexible tension member comprises a cable.
